(19) United States
(12) Patent Application Publication
(10) Pub. No.: US 2008/0222553 A1
(43) Pub. Date: Sep. 11, 2008

(54) CHEF PC

(76) Inventor: Verna Benjamin-Lambert, Kennesaw, GA (US)

Correspondence Address: WILSON DANIEL SWAYZE, JR., 3804 CLEARWATER CT., PLANO, TX, 75025, US

(21) Appl. No.: 11/684,174

(22) Filed: Mar. 9, 2007

(51) Int. Cl. G06F 3/048

(52) U.S. Cl. 715/779; 715/810

(57) ABSTRACT

An apparatus for displaying recipe information includes an output device for displaying an icon to display the recipe information, a central processing unit for controlling set up a device and a memory for storing the recipe information.

### FIELD OF THE INVENTION

Embodiments of the present invention provide a method and apparatus providing for navigation, viewing, internet exchange, maintenance and manipulation of food recipes and other food-related information.

### BACKGROUND OF THE INVENTION

The present invention relates to a recipe computer system and method. More specifically, it relates to use of a recipe computer to aid in the preparation of a plurality of dishes. (As used herein, “dish” shall mean a particular kind of food, not a plate or other container for food. “Dishes” will likewise refer to a several particular kinds of food.)

When preparing a meal, it is difficult for an individual to keep track of all the menus that the individual may wish to have available when planning for a meal. Furthermore, the individual may not know if the ingredients for the meal are available. It would be desirable to be able to build a grocery list which would include the items to be purchased when the individual visits the grocery store.

Various U.S. patents have disclosed techniques of helping a cook with the steps in preparing a meal and related areas.

US patent to Barnett, U.S. Pat. No. 6,381,614, discloses a system and method for recipe integration providing a single timeline for a cook preparing a meal of several different dishes. A food recipe integration computer combines steps from the recipes of the individual dishes and de-conflicts steps as necessary such that the cook is not required to perform multiple actions at once. The single timeline is a list of steps and corresponding times for preparing the dishes to be ready at the selected times. The time allocated to a given step may be greater for a beginning cook than for a more skilled cook. Optionally, one or more steps in a list are more detailed for less skilled cooks and less detailed for cooks having higher skills.

The Overbeck Patent, U.S. Pat. No. 4,807,169, patent discloses a food preparation information system whereby preparation instructions are supplied in sequence. Its abstract refers to combining and preparing food dishes. Different dishes are combined for the cook's consideration, but the individual steps in the preparation and cooking of those dishes are apparently left to the cook to coordinate. Instead of requiring a cook to shift between recipes on different pages (from a single cook book or multiple cook books), it apparently requires the cook to use menu (dish) jump or skip keys to shift between different dishes or between different meals.

The Brenner U.S. Pat. No. 5,960,440 shows a recipe database system with timers for various preparation steps. The system allows easy switching between an ingredient list and a preparation instruction list. It adjusts ingredient amounts depending on serving size.

The Hungerford U.S. Pat. No. 4,872,112 patent shows a recipe calculator that scales recipes depending on the number of servings that are being prepared.

The Stanley U.S. Pat. No. 4,405,991 patent is a kitchen calculator for determining cooking time based on the quantity that is being cooked.

The Del Giomo U.S. Pat. No. 5,899,502 patent discloses a system that personalizes recipes based on food allergies and preferences.

Both the Horinouchi U.S. Pat. No. 4,517,429 patent and the Petty U.S. Pat. No. 5,877,477 patent disclose ovens with heating controlled by a recipe in a database.

Although some of the prior arrangements have been generally useful, they have often been subject to one or more of several disadvantages. Many prior cook helping processes or devices have insufficient flexibility in meal planning. For example, instructions for an entire pre-planned meal (consisting of several individual dishes) are available in cookbooks, CDs, the internet, and floppy disks. However, changes to these pre-planned meals are not possible. Instructions are for a single group of dishes in a single meal. Substitutions are not possible. The inability to pick a side dish from one meal plan and a main dish from another meal plan is a real limitation on the adaptability of those arrangements using pre-planned meals. Generally, prior processes or devices do not provide as much help to a cook as is desirable.

### OBJECTS AND SUMMARY OF THE INVENTION

Accordingly, it is a primary object of the present invention to provide a new and improved recipe computer system and method.

A further object of the present invention is to provide an extremely flexible and powerful technique to help cooks.

A further object of the present invention is to help cooks so that their energies can be directed to observing and controlling various cooking processes, instead of recalling routine information such as specific orders of steps or specific times of taking actions.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the first menu of the present invention;

FIG. 2 illustrates a second menu of the present invention;

FIG. 3 illustrates a third menu of the present invention;

FIG. 4 illustrates a fourth menu of the present invention;

FIG. 5 illustrates a diagram of the present invention;

FIG. 6 illustrates a system of the present invention.

### DETAILED DESCRIPTION

The above and other features of the present invention which will be more readily understood when the following detailed description is considered in conjunction with the accompanying drawings are realized by a process for automatic food recipe integration as an aid to a cook. While recipe information includes recipes, meals, grocery lists and inventory, recipes include the steps of preparing the dishes; meals include different foods prepared by different recipes; grocery lists include the ingredients for the recipes; and inventory includes the ingredients and associated items which are associated with the ingredients.

FIG. 6 illustrates a system in accordance with the present invention, and the system 600 which could be a POS system and includes a central processing unit CPU 602 which is connected to an output device 604 which may be a screen of a monitor to display the recipes, meals, inventory and grocery list and other associated data. The CPU 602 is additionally connected to an input device 608 which may be a keyboard or a touchscreen and connected to a memory 606.

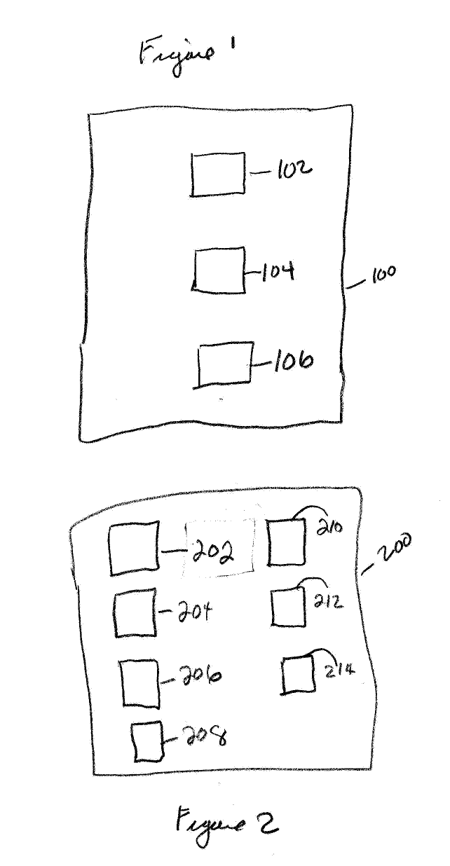

FIG. 1 illustrates a first touchscreen 100 which includes a first icon 102 of a first touchscreen 100 for obtaining recipes, a second icon 104 of the first touchscreen 100 for obtaining meals and a third icon 106 of the first touchscreen 100 for obtaining grocery and inventory information.

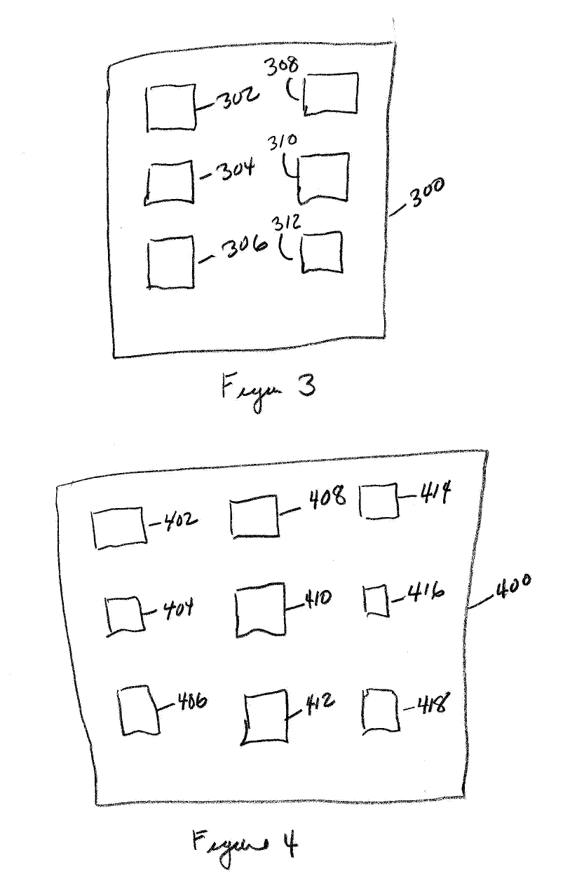

FIG. 2 illustrates a second touchscreen 200 which is used to generate recipes and which includes a first icon 202 of the second touchscreen 200 to provide general global recipes, a second icon 204 of the second touchscreen 200 to generate cultural recipes, and a third icon 206 of the second touchscreen 200 to provide ethnic recipes. The second touchscreen 200 includes a fourth icon 208 of the second touchscreen 200 to provide a menu, a fifth icon 210 of the second touchscreen 200 to provide the best recipes by specific cooks, a sixth icon 212 of the second touchscreen 200 to provide the recipes of celebrity favorites and a seventh icon 214 of the second touchscreen 200 to provide grandmas recipes. The various recipes are stored in the memory 606, and the CPU 602 will retrieve the recipes from the memory 606 and display the recipes on the output device 604 when the icons 202, 204, 206, 208, 210, 212, 214 are selected by the user. Other types of recipes can be viewed by additional icons.

FIG. 3 illustrates the third touchscreen 300 of the present invention to display various types of meals prepared. The third touchscreen 300 includes a first icon 302 of the third touchscreen 300 to display dietary meals, a second icon 304 of the third touchscreen 300 to display vegetarian meals, a third icon 306 of the third touchscreen 300 to display recommended meals for diabetics, and a fourth icon 308 of the third touchscreen 300 to display recommended meals for individuals with intestinal problems. The third touchscreen 300 includes a fifth icon 310 of the third touchscreen 300 to display recommended meals for individuals with high blood pressure and a sixth icon 312 of the third touchscreen 300 to display meals for infants, toddlers etc. The CPU 602 displays the meals on the output device 604. Other icons can be added to display additional types of meals.

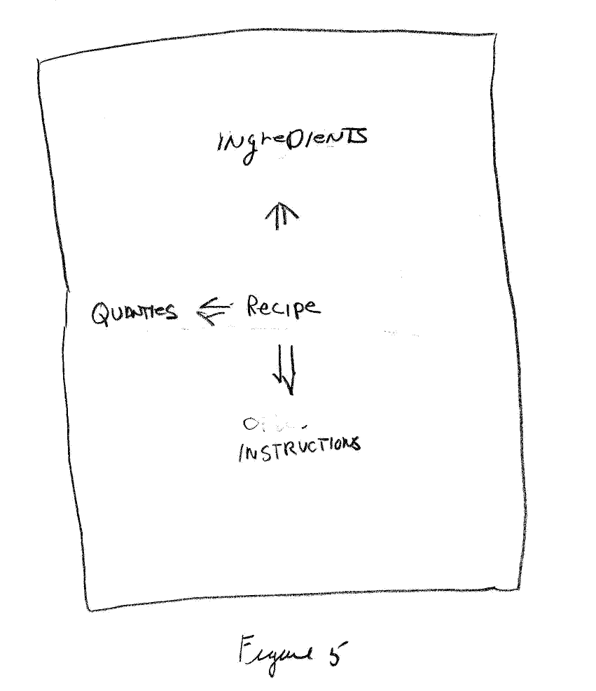

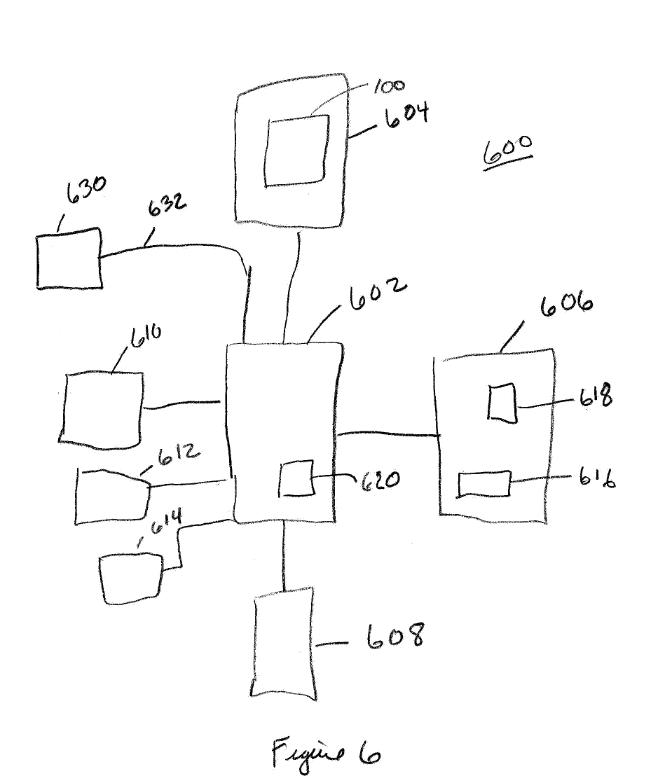

FIG. 4 illustrates the fourth touchscreen 400 to display grocery and inventory information. The fourth touchscreen 400 includes a first icon 402 of the fourth touchscreen 400 to display the current grocery list which is stored within the memory 606, a second icon 404 of the fourth touchscreen 400 to create a customized grocery list of items to the purchased, a third icon 406 of the fourth touchscreen 400 to recognize frequently used items and to identify when restocking these items is necessary. The fourth touchscreen 400 includes a fifth icon 410 of the fourth touchscreen 400 to direct the CPU 602 to fax by the fax machine 610 the grocery list to the grocery store or to send an e-mail with a grocery list 616 to the grocery store, a sixth icon 412 of the fourth touchscreen 400 to create and store in the memory 606 a custom recipe created by the user and a seventh icon 414 of the fourth touchscreen 400 to calculate and adjust portions of the recipe for example by one half or one quarter based upon the amount of servings required. Also, fourth touchscreen 400 will accept the number of people going to be served and convert that to a recipe with the appropriate quantities to be used. The fourth touchscreen 400 includes an eight icon 416 of the fourth touchscreen 400 to activate a medication reminder using a beeping device timer 612 which is activated by the CPU 602 and a ninth icon 418 of the fourth touchscreen 400 to activate an alert device 614 to send a message to the output device 604 to indicate if an ingredient is not available for selected recipe and to place that ingredient onto the grocery list 616 stored in memory 606 if the ingredient is not available. The CPU 602 maintains the inventory 618 of ingredients in memory 606. The CPU 602 includes voice recognition circuitry 620 so that the output device 604 will respond to the voice of the user with the above functions. Furthermore, the output device 604 is user-friendly with people suffering from disabilities such as users who cannot see and require Braille. The above information is displayed by the CPU 602 on the output device 604. The present invention could be incorporated into a hand device, installed on the wall of a house or placed on the countertop of the counter. FIG. 5 illustrates the components of the recipe which include the ingredients, the quantities of the ingredients and the instructions of how the ingredients should be combined.

The CPU 602 will manage an internet exchange component which will be linked by Internet connection 632 with a website 630 where uploads of various recipes stored in the memory 606 will be included. The site in the 630 will also be the repository for the grocery store order lists (perhaps w/links to store sites) and chef pc members/users recipe exchange via email stored in the memory 606. The Internet site 630 may contain a chat center and forums where users can dialogue about recipes and send the recipes to each other. The CPU 602 manipulates the recipes stored within the memory 606 and will provide potential altered diet recipes, as well as fulfill a nutrition function by providing a list of substitute ingredients which will be available for those trying to stay under certain caloric or fat thresholds.

Each recipe in the memory 606 should include nutrition info and suggestions for substitute ingredients to lower bad calorie intake. Also, the memory 606 should include substitute shortcut recipes for scratch recipes where time is restricted. Chefpc will be the name and function of the apparatus and website, while each unit will eventually have a mychefpc profile with the user's own preferences and personal recipes. This way, the user can either tap into a vast already existing database, or create one entirely of her own. Furthermore, mychefpc profiles will have a password protected function that limits viewing and exchange of certain recipes. The website 630 will also contain private forums where certain members sign up to have an open exchange between their individual mychefpcs, also password protected. This will give outside users the ability to view and import all recipes in another's profile that are not password protected. Each unit will be able to access the internet 632 individually.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An apparatus for displaying recipe information, comprising:
an output device for displaying a icon to display said recipe information;
a central processing unit for controlling set up a device;
a memory for storing said recipe information.

2. An apparatus for displaying recipe information as in claim 1, wherein said recipe information includes general global recipes.

3. An apparatus for displaying recipe information as in claim 1, wherein said recipe information includes cultural recipes.

4. An apparatus for displaying recipe information as in claim 1, wherein said recipe information includes best recipes by specific cooks.

5. An apparatus for displaying recipe information as in claim 1, wherein said recipe information includes celebrity favorites.

6. An apparatus for displaying recipe information as in claim 1, wherein said recipe information include dietary meals.

7. An apparatus for displaying recipe information as in claim 1, wherein said recipe information includes meals for individuals with intestinal problems.

8. An apparatus for displaying recipe information as in claim 1, wherein said recipe information includes meals for individuals with high blood pressure.

9. An apparatus for displaying recipe information as in claim 1, wherein said recipe information includes meals for infants or toddlers.

10. An apparatus for displaying recipe information as in claim 1, wherein said recipe information includes a grocery list.

11. An apparatus for displaying recipe information as in claim 1, wherein said recipe information includes a created and customized grocery list.

12. An apparatus for displaying recipe information as in claim 1, wherein said recipe information includes inventory information.

13. An apparatus for displaying recipe information as in claim 12, wherein said inventory information includes information to identify when restocking is necessary.

14. An apparatus for displaying recipe information as in claim 1, wherein said central processing unit includes a fax to fax the grocery list to the grocer.

15. An apparatus for displaying recipe information as in claim 1, wherein said central processing unit controls a beeping device timer.

16. An apparatus for displaying recipe information as in claim 1, wherein said central processing unit since a large signal when the inventory does not include a item from the recipe.

17. An apparatus for displaying recipe information as in claim 1, wherein said central processing unit includes voice recognition circuitry.

18. An apparatus for displaying recipe information as in claim 1, wherein said apparatus is adapted to be handheld.

19. An apparatus for displaying recipe information as in claim 1, wherein said apparatus is adapted to be mounted on the wall.

20. An apparatus for displaying recipe information as in claim 1, wherein said apparatus is adapted to be mounted on the countertop.
